(19) United States
(12) Patent Application Publication
(10) Pub. No.: US 2004/0193395 A1
(43) Pub. Date: Sep. 30, 2004

(54) Program analyzer for a cycle accurate simulator

(76) Inventor: Dominic Paulraj, Sunnyvale, CA (US)

Correspondence Address: HAMILTON & TERRILE, LLP, P.O. BOX 203518, AUSTIN, TX, 78720, US

(21) Appl. No.: 10/397,439

(22) Filed: Mar. 26, 2003

(51) Int. Cl. G06F 17/50

(52) U.S. Cl. 703/22

(57) ABSTRACT

A method for analyzing performance using a cycle accurate simulator. The cycle accurate simulator executes snapshots extracted from an application, collects performance metrics from the cycle accurate simulator, and dumps this information onto a file. A tool reads the metric file for all the snapshots and maps these metrics at instruction, function and at the source code level.

### BACKGROUND OF THE INVENTION

1. Field of the Invention

The present invention relates to the field of performance analysis and more particularly to program analysis tools used with processors under development.

2. Description of the Related Art

During the development of microprocessors, various designs are proposed and modified. Each design is tested for persistent errors (i.e., bugs) and for performance (i.e., speed), and modified accordingly to remove persistent errors and/or improve performance. Ultimately, a design is deemed sufficiently error-free and fast to be frozen and converted to hardware.

Various software representations of the processor are employed during development. For example, a logical representation of the processor is provided in a hardware design language (“HDL”) such as Verilog. The HDL representation is often an inchoate description of the processor hardware. Ultimately, when the processor design is frozen, the HDL representation is converted to an arrangement of gates capable of implementing the processor logic on a semiconductor integrated circuit chip.

Other software representations of the processor are used to evaluate the performance of HDL designs. One such software representation is all architectural model which contains a relatively high level description of the processor's architecture.

One of the shortcomings of architectural models is the inability of the architectural model to accurately model the cycle-by-cycle performance of the processor. Another type of processor model, a “cycle accurate model,” contains a sufficiently detailed representation of the processor to maintain cycle-by-cycle correspondence with the actual processor.

Since cycle accurate models run hundreds of magnitude slower than an actual processor, instead of running an entire application on this model, defined sets of snapshots are taken from the original application and run. To preserve the original application behavior on the snapshot, each snapshot includes cache warning information, branch warning information, TLB warning information and other states of the application up to the snap point. Snapshots also include instruction traces with the associated program counter and register values for each instruction.

Cycle accurate models provide performance measures by running snapshots taken from the benchmark programs, such as the average number of cycles required to execute an instruction, the rate at which the data cache is accessed and missed, and other performance statistics such as stall cycles. These performance measures provide the overall summary statistics. This summary is useful only to get the performance of the entire application. However, this summary statistic is of little or no use to low level performance engineers who like to find potential bottlenecks in the application.

Usually, a processor design and development effort is overlapped with a compiler development for the same processor. The back end of the compiler is tuned to a specific architecture based on detailed performance analysis on the cycle accurate simulator models. It becomes extremely difficult for compiler developers to look at the hot blocks in the code and tune their code to bypass some of the potential architecture bottlenecks passed only on summary statistics.

What is important for compiler developers and performance analysis engineers is to obtain performance statistics details drilled down to each instruction in the program. Mapping instructions to higher level function and source level provides performance bottleneck at function level and at source level. These kind of details are not provided by the cycle accurate simulator models.

### SUMMARY OF THE INVENTION

In accordance with the present invention, a cycle accurate simulator model is enhanced so that the cycle accurate model collects substantially all the relevant statistics (like cycles, cache misses, stall cycles, etc.) for each instruction and the collected performance statistics is stored in a file. A program analyzer for a cycle accurate simulator is provided which reads the performance statistics from the file for each instruction retired and maps the program counter (PC) to instruction level, function level and the source level.

Additionally, the invention relates to a method for analyzing performance using a cycle accurate simulator. The cycle accurate simulator executes a snapshot of a program, collects all possible metrics (such as cache misses, cycle count and stall cycles) from the cycle accurate simulator, and dumps them into a file. Another tool reads these metrics from the file and maps the metrics to the program at instruction, function and source level.

In one embodiment, the invention relates to a method for analyzing performance using a cycle accurate simulator. The cycle accurate simulator executes a program on a processor model, collects data and instruction trace information from the processor model, obtains snapshot information and cache warming information from the data and instruction trace information, executes snapshot information on the cycle accurate simulator, collects performance information from the cycle accurate simulator, and analyzes the performance information to identify possible performance enhancements to the processor.

In another embodiment, the invention relates to an apparatus for analyzing performance using a cycle accurate simulator which includes means for executing a program on a processor model, means for collecting data and instruction trace information from the processor model, means for obtaining snapshot information and cache warming information from the data and instruction trace information, means for executing the snapshot information on the cycle accurate simulators means for collecting performance information from the cycle accurate simulator, and means for analyzing the performance information to identify possible performance enhancements to the processor.

In another embodiment, the invention relates to a simulator which includes a processor model, a cycle accurate simulator, and a performance statistic analyzer. The processor model receives and provides information to a trace file to execute a program, collecting trace information from the processor model via the trace file. The cycle accurate simulator obtains snapshot information and cache warming information from the trace information and executes the snapshot information on the cycle accurate simulator. The performance statistic analyzer collects performance information from the cycle accurate simulator and analyzes the performance information.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a block diagram of a computer system which may be used to run a simulator of the present invention.

FIG. 2 is a block diagram showing a simulator in accordance with the present invention.

FIG. 3 is a block diagram showing a processor model employed in a simulator of the present invention.

FIG. 4 is a table detailing how a superscalar processor can pipeline instructions.

FIG. 5 is a block diagram showing the overall process by which a simulator uses a benchmark program to generate performance statistics for a processor design.

FIG. 6 is a process flow diagram for collecting the performance data with the simulator.

FIG. 7 is a process flow diagram for interpreting the performance data.

FIG. 8 shows a diagrammatic block diagram of the information produced during the operation of the simulator.

FIG. 9 shows an example of a screen presentation generated by the performance analyzer.

### DETAILED DESCRIPTION

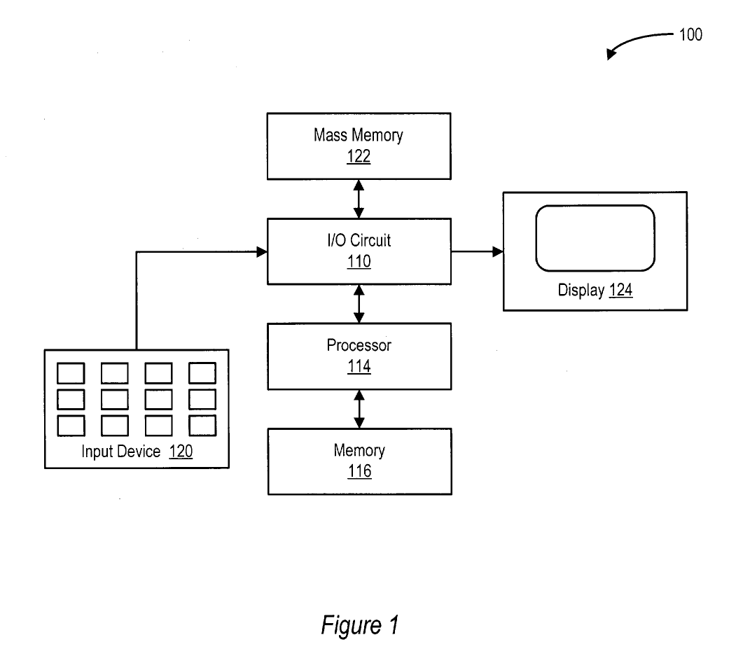

FIG. 1 shows a typical computer system 100 on which a simulator may be executed. Computer system 100 includes an input/output circuit 110 used to communicate information in appropriately structured form to and from the parts of computer 100 and associated equipment, a processor 114, and a memory 116. These components are those typically found in most general and special purpose computer systems 100 and are intended to be representative of this broad category of information handling systems.

The computer system 100 also includes an input device 120 shown as, e.g., a keyboard. The input device 120 may be any well-known input device. A mass memory device 122 is coupled to the input/output circuit 110 and provides additional storage capability for the computer system 100. The mass memory device 122 may be used to store programs, data, instruction structures, and the like. It will be appreciated that the information retained within the mass memory device 122, may, in appropriate cases, be incorporated in standard fashion into computer 100 as part of the memory 116.

The computer system 100 also includes a display 124 which is used to present the images. Such a display 124 may take the form of any of several well-known varieties of cathode ray tube displays, flat panel displays, or other known types of display.

The memory 116 may store programs and/or objects which represent sequences of instructions for execution by the processor 114. For example, the programs and/or objects making up a cycle accurate model of this invention may be stored within the memory 116.

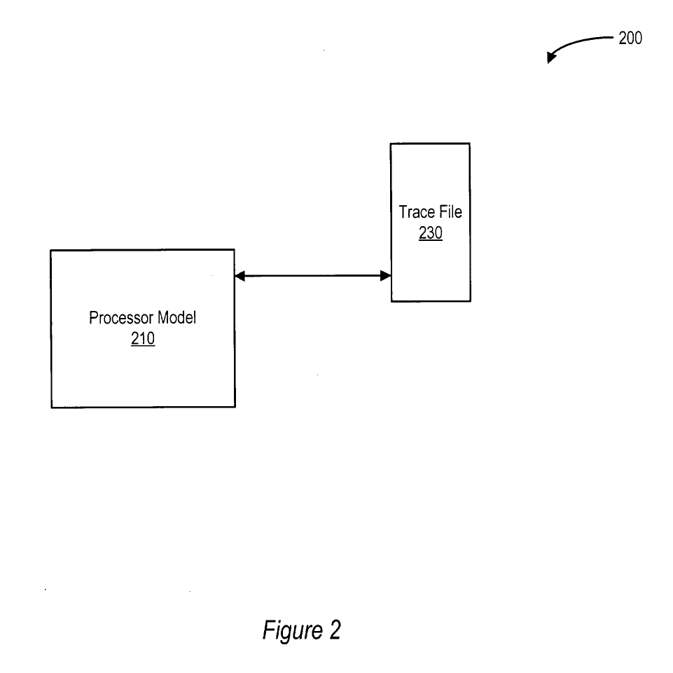

FIG. 2 is a block diagram of the main elements of a simulator 200. Included in the simulator 200 is a processor model 210 which receives instructions from and provides data to a trace file 230. The instructions in trace file 230 are made available at processor model 210 via, e.g, a trace buffer, not shown.

Processor model 210 is a cycle accurate model of an actual hardware processor or an HDL representation of a processor. However, it may more generally be any execution driven processor model such as an instruction accurate model. It is assumed that during development of a processor, all changes to the HDL representation of the processor are reflected in the processor model 210 so that simulated processor model 210 provides a realistic representation of the actual hardware processor at any given stage of development.

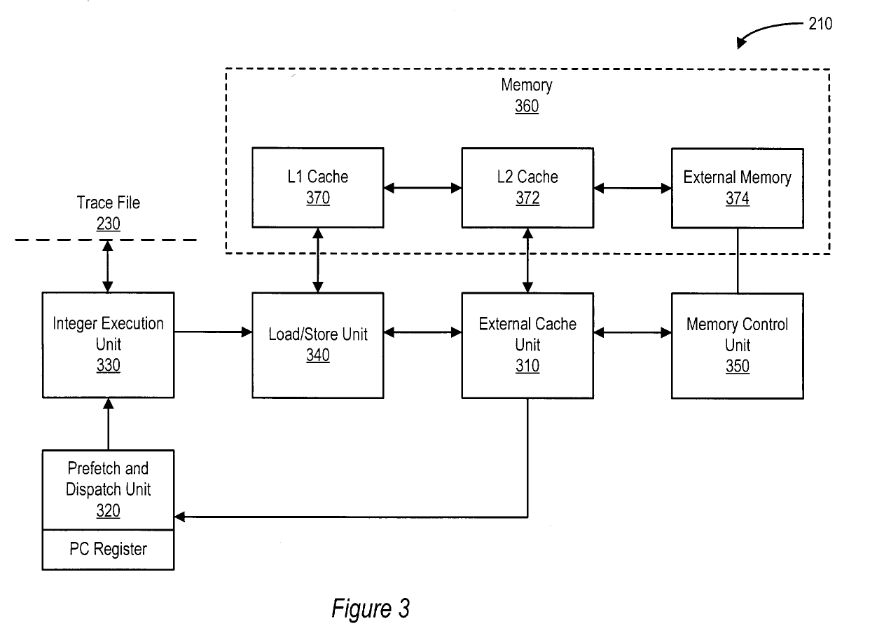

Referring to FIG. 3, certain details of an exemplary processor model 210 such as, for example, a SPARC processor available from Sun Microsystems, Inc. are shown. The processor model 210 includes modules for modeling an external cache unit (“ECU”) 310, a prefetch and dispatch unit (“PDU”) 320, all integer execution unit (“IEU”) 330, a LOAD/STORE unit (“LSU”) 340 and a memory control unit (MCU) 350, as well as a memory 360. Memory 360 includes modules representing a level 1 cache (L1 cache) 370, a level 2 cache (L2 cache) 372 and an external memory 374. Other cache levels may also be included with the memory model. The level 1 cache 370 interacts with the load store unit 340 and the level 2 cache. The level 2 cache 372 interacts with the level 1 cache 370, the external memory 374 and the external cache unit 310. The external memory 374 interacts with the level 2 cache 342 and the memory control unit 350.

In preferred embodiments, each of these processor units are implemented as software objects, and the instructions delivered between the various objects which represent the units of the processor are provided as packets containing such information as the address of an instruction, the actual instruction word, etc. By endowing the objects with the functional attributes of actual processor elements, the model can provide cycle-by-cycle correspondence with the HDL representation of the processor being modeled.

Memory 360 stores a static version of a program (e.g. a benchmark program) to be executed on processor model 210. The instructions in the memory 360 are provided to processor 210 via the memory control unit 360. The instructions are then stored in external cache unit 310 and are available to both prefetch and dispatch unit 320 and a LOAD/STORE unit 340. As new instructions are to be executed, the instructions are first provided to prefetch and dispatch unit 320 from external cache unit 310. Prefetch and dispatch unit 320 then provides an instruction stream to integer execution unit 330 which is responsible for executing the logical instructions presented to the integer execution unit 330. LOAD or STORE instructions (which cause load and store operations to and from memory 360) are forwarded to LOAD/STORE unit 340 from integer execution unit 330. The LOAD/STORE unit 340 may then make specific LOAD/STORE requests to external cache unit 310.

The integer execution unit 330 receives previously executed instructions from trace file 230. Some trace file instructions contain information such as the effective memory address of a LOAD or STORE operation and the outcome of a decision control transfer instruction (i.e., a branch instruction) during a previous execution of a benchmark program. Because the trace file 230 specifies effective addresses for LOADS/STORES and branch instructions, the integer execution unit 330 is adapted to defer to the trace file instructions 230.

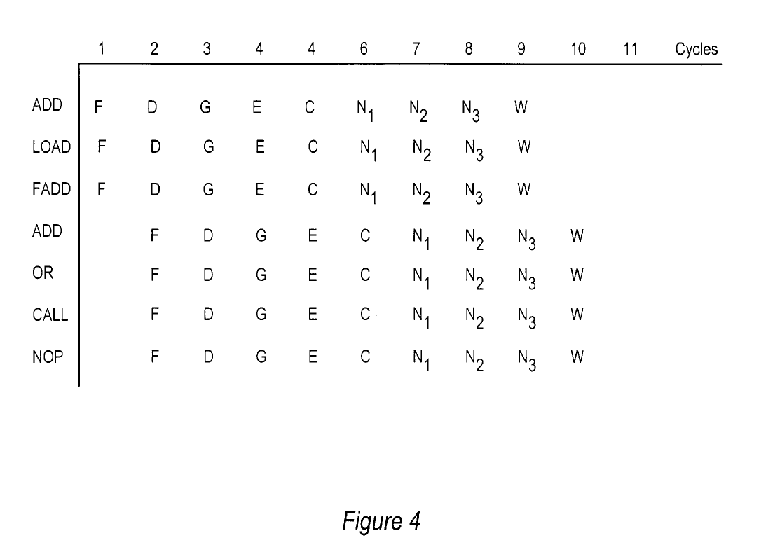

The objects of the processor model 210 accurately model the instruction pipeline of the processor design the model represents. More specifically, FIG. 4 presents an exemplary cycle-by-cycle description of how seven sequential assembly language instructions might be treated in a superscalar processor which can be appropriately modeled by a processor model 210. The various pipeline stages, each treated in a separate cycle, are depicted in the columns of FIG. 4. The prefetch and dispatch unit 320 handles the fetch (F) and decode (D) stages. Thereafter, the integer execution unit 330 handles the remaining stages which include application of the grouping logic (G), execution of Boolean arithmetic operations (E), cache access for LOAD/STORE instructions (C), execution of floating point operations (three cycles represented by N₁-N₃), and insertion of values into the appropriate register files (W). Among the functions of the execute stage is calculation of effective addresses for LOAD/STORE instructions. Among the functions of the cache access stage is determination if data for the LOAD/STORE instruction is already in the external cache unit.

In a superscalar architecture, multiple instructions can be fetched, decoded, etc. in a single cycle. The exact number of instructions simultaneously processed is a function of the maximum capacity of pipeline as well as the “grouping logic” of the processor. In general, the grouping logic controls how many instructions (typically between 0 and 4) can be simultaneously dispatched by the IEU. Grouping logic rules may be divided into two types: (1) data dependencies, and, (2) resource dependencies. The resource is the resource available on the processor. For example, the processor may have two arithmetic logic units (ALUs). If more than two instructions requiring use of the ALUs are simultaneously presented to the pipeline, the appropriate resource grouping rule will prevent the additional arithmetic instruction from being submitted to the microprocessor pipeline. In this case, the grouping logic has caused less than the maximum number of instructions to be processed simultaneously. An example of a data dependency rule is if one instruction writes to a particular register, no other instruction which accesses that register (by reading or writing) may be processed in the same group.

In this example shown in FIG. 4, the first three instructions, ADD, LOAD and FADD (floating point add), are simultaneously processed in a superscalar pipeline. The next successive instruction, an ADD instruction, is not processed with the proceeding three instructions because, for example, the processor being modeled has the capacity to treat only two ADD (or FADD) instructions in a single cycle. Thus, the second ADD instruction (the fourth overall instruction) is processed with the next group of instructions: ADD, OR, CALL and NOP.

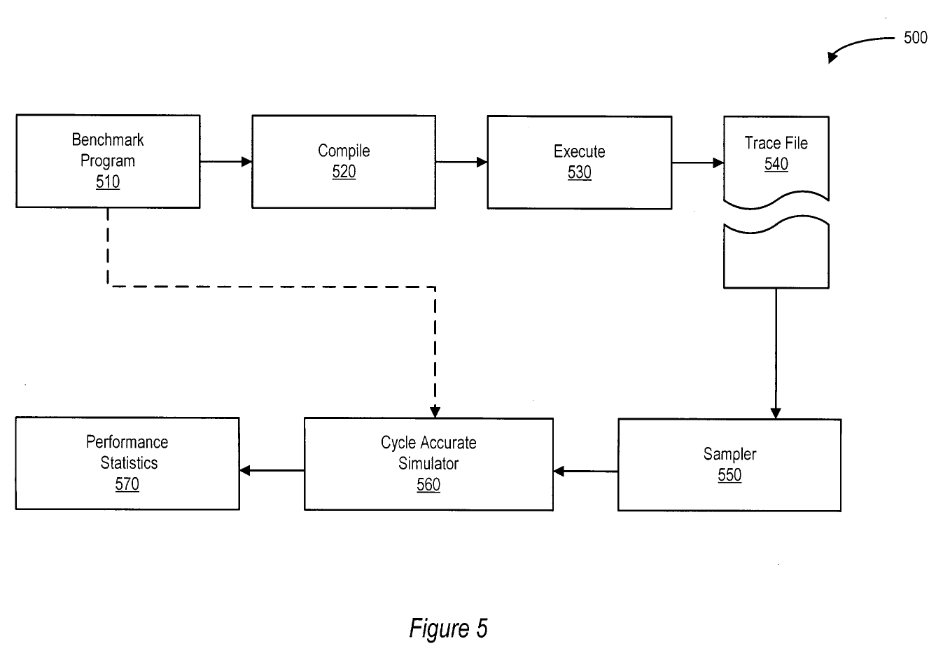

Referring to FIG. 5, a tile sequence of events by which a simulator 500 employs a benchmark program to generate performance statistics is shown. Initially, a static benchmark program 510 is compiled at a step 520 to produce a machine language version of the program which is executed by the processor model 210 at a step 530. When executed on the processor model 210, the benchmark program 610 generates a trace file 540. For example, for a conventional benchmark program, the trace file 540 might contain on average about 20 million instructions.

The trace file 540 is analyzed to obtain snapshot information and cache warming information by sampler 550. Thereafter, the snapshot information and the cache warming information are provided to a cycle accurate simulator 560. The cycle accurate simulator 560 uses the information contained in the traces, in conjunction with static benchmark program 510, to generate a collection of performance statistics 570. Exemplary performance statistics include the total number of cycles required to execute a benchmark, the average number of cycles to execute an instruction in the benchmark, the number of times that cache was accessed. Other performance statistics include cache miss information such as level 1 cache miss information, level 2 cache miss information and memory miss information, stall cycle information for particular instructions (i.e., a number of cycles that an instruction is waiting to complete execution), and retirement cycles for particular instructions (i.e., how many cycles it takes for an instruction to retire). The stall cycle information may be further specified to include the number of cycles that an instruction is waiting for data in the cache, the number of cycles that an instruction is waiting for a functional unit to become available, and the number of cycles that an instruction is waiting for an internal processor buffer to become available.

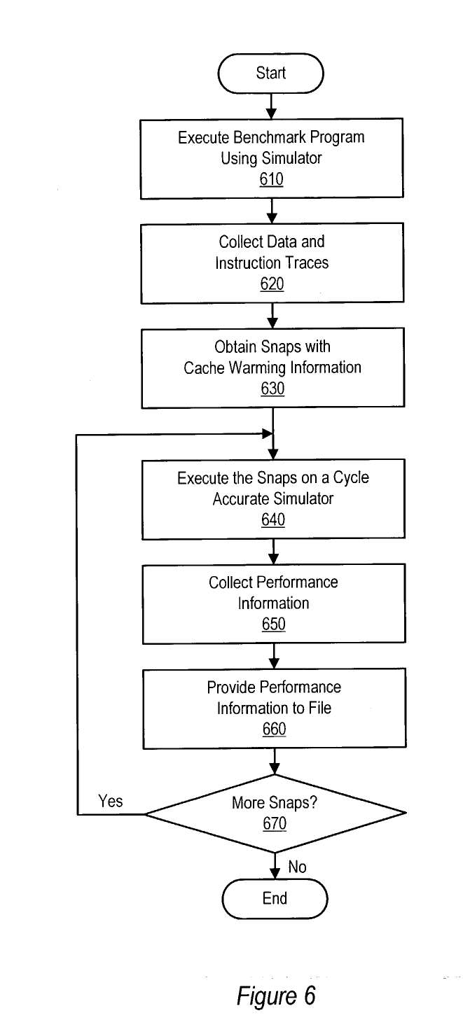

Referring to FIG. 6, the steps involved in evaluating the performance of the future processors are shown. More specifically, the benchmark program 510 is executed using the simulator 210 at step 610. While the benchmark program 510 is executing, data and instruction traces are collected at step 620. The data and instruction traces that were collected at step 620 are used to take snapshots of the information including cache warming information at step 630. These snapshots (including the cache warming information) are then executed a cycle accurate simulator at step 640. During the execution of the snapshots, performance information such as cache misses, CPI, IPC branch statistics, etc. is collected at step 650. Next the performance information for a snapshot is provided to a file at step 660. The snap and cache warming information is then reviewed to determine whether there are any more snaps to analyze at step 670. If so, then the next snap file is executed on the cycle accurate simulator. If not, then the collecting portion of the evaluation process ends.

On completion of collecting the statistics for each snap, the results can be accumulated and used to predict the overall performance of a processor. These statistics may be useful for an existing application to determine known applications will run on a new processor design. However, the statistics generated may not yield the maximum performance for the future processor. Because a future processor may have more functional units and other features which are not used in the existing application. To obtain the maximum peak performance for a new processor, it is desirable to tune the compiler. Tuning the compiler is based on how well that future processor executes a set of instructions. The simulator 500 allows a processor designer to obtain statistics at instruction level and globally at function level.

The simulator 500 provides a method of collecting such statistics. Whether the future processor is an in-order processor or an out-of-order processor or cache simulator, the tool collects data or each instruction. When an instruction is executed by the cycle accurate simulator or a cache simulator, data regarding what is happening in the pipeline is recorded for each instruction. For example, the amount of cycles spent is calculated as a delta cycle between two consecutive retired instructions. The collected data generates performance information which is then stored in a file, e.g., at step 660. The file contains the performance statistics for each instruction.

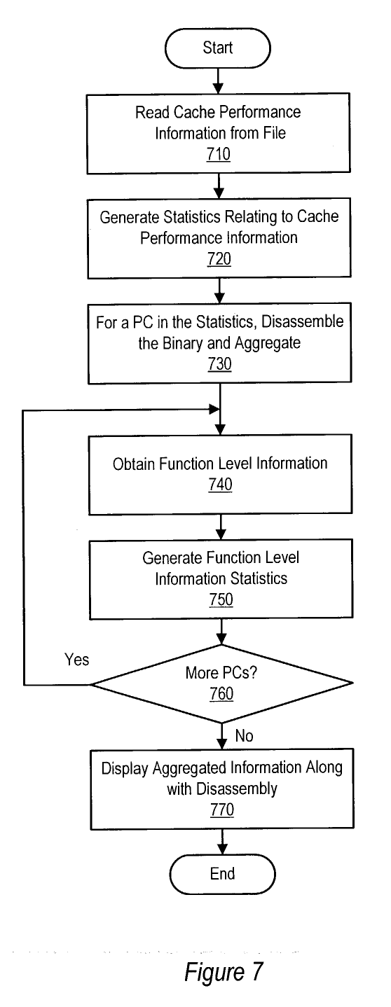

Referring to FIG. 7, the performance information file is read to provide statistics at instruction and function level. The statistics and the binary from the benchmark program 510 are read at step 710. For each PC in the performance information, statistics relating to the performance are generated at step 720. Next the binary is disassembled and aggregated for each PC at step 730. Because the PC is known from the performance statistics, the function level information is obtained from PC and function addresses at step 740. Based on this function level information, function level statistics are generated at step 750.

The system then reviews the statistics and the binary from the benchmark program at step 770 to determine whether there are any more PCs to analyze. If so, then the function level information is obtained for the next PC at step 740. If not, then the aggregated information is displayed along with the disassembly at step 770.

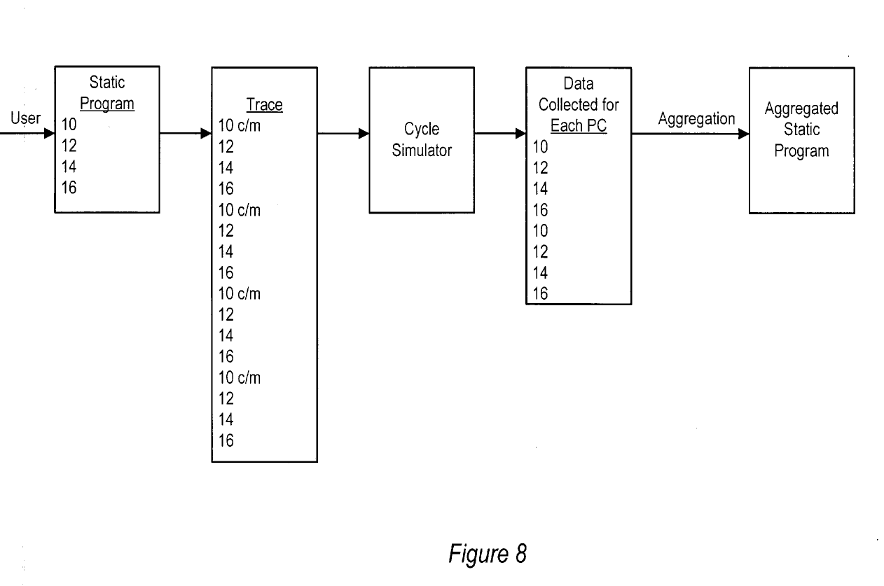

Referring to FIG. 8, a diagrammatic block diagram of the information produced during the operation of the simulator 500 is shown. More specifically, the information from the initial static program file is expanded to a trace file. This trace file is then passed through the cycle accurate simulator and performance data is collected from the cycle accurate simulator based upon the execution of the trace file by the cycle accurate simulator. This collected performance data is then aggregated with information relating to the initial static program to provide an aggregated static program listing with associated information for each instruction within the static program. Accordingly, a developer may view information generated by the cycle accurate simulator for each PC of the original static program by accessing a particular PC.

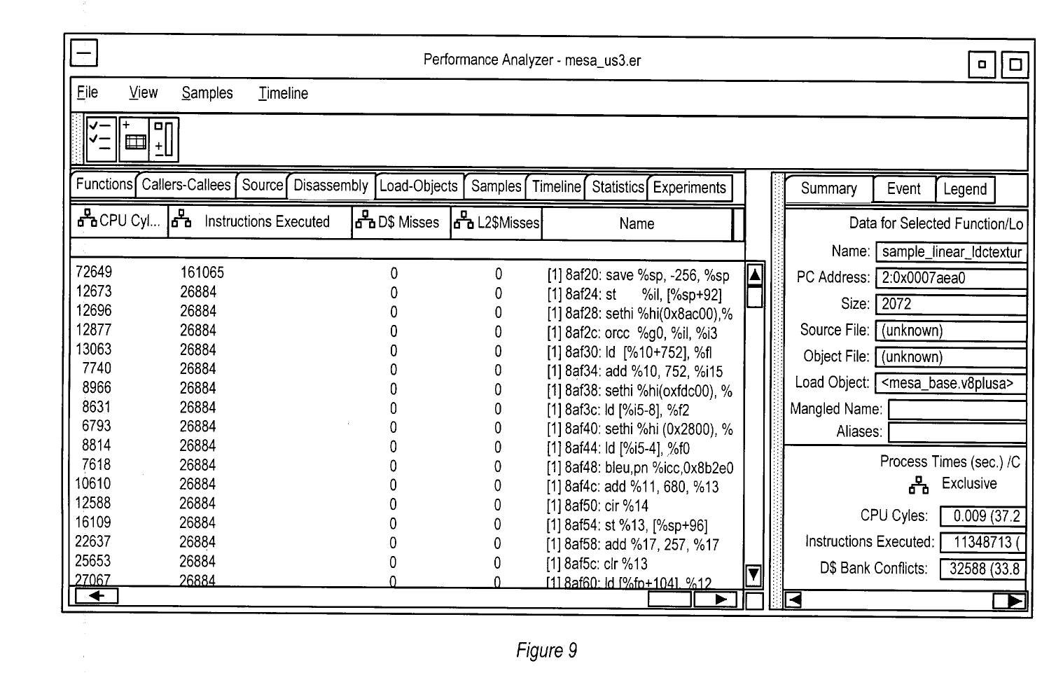

Referring to FIG. 9, an example of a performance analyzer screen presentation generated by the simulator is shown. The performance analyzer screen presentation includes an instruction listing portion 910 as well as a specific instruction information portion 920.

The instruction listing portion 910 lists the instructions based upon one of a plurality of characteristics. The list of instructions that is presented is determined by selecting one of a plurality of tabs. The tabs includes a Functions tab, a Callers-Callees tab, a Source tab, a Disassembly tab, a Load-Objects tab, a Samples tab, a Timeline tab, a Statistics tab, and an Experiment tab.

The instruction listing portion 910 lists instructions and presents information relating to the instructions. The information relating to the instructions includes the CPU cycle of the instruction, the number of instructions executed at a particular CPU cycle, the number of data cache misses for a particular CPU cycle, the number of level 2 cache misses for a particular CPU cycle and the name of the instruction at a particular CPU cycle.

The specific instruction information portion 920 provides information relating to a particular selected instruction from the instruction listing portion 910. The specific instruction information portion 920 includes a data portion 930 and a process time portion 940. The data portion 930 of the specific instruction information portion 920 presents information setting forth the name of the selected instruction, the PC address of the selected instruction, the size of the data for selected instruction, the source file for the data of the selected instruction, the object file of the data of the selected instruction, the load object of the data of the selected instruction, the mangled name of the data of the selected instruction and the aliases of the data of the selected instruction.

The process time portion 940 of the specific instruction information portion presents information which is both exclusive and inclusive. If the instruction is a subroutine call, then the inclusive value provides the total time spent within the called routine, the exclusive value does not include the time spent in the called routine. More specifically, the process time portion 940 of the specific instruction information portion presents information setting forth the number of cycles used in executing the specific instruction the number of instructions executed, the data cache misses generated by the specific instruction, the number of level 2 cache misses generated by the selected instruction, the message driven bean (MDB) raw count for the selected instruction, the number of over eager loads of the selected instruction, and the number of data cache conflicts of the selected instruction.

Accordingly, using the presentations provided by the simulator, a developer may view information generated by the cycle accurate simulator for each instruction PC of the original static program by accessing a particular instruction PC.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for analyzing performance using a cycle accurate simulator comprising:
executing a program on a processor model;
collecting data and instruction trace information from the processor model;
obtaining snapshot information and cache warming information from the data and instruction trace in formation;
executing the snapshot information on the cycle accurate simulator;
collecting performance information from the cycle accurate simulator;
mapping the performance statistics to instruction level, function level and source level; and
analyzing the performance information to identify possible performance enhancements to the processor.

2. The method of claim 1 further comprising:
aggregating the performance information from the cycle accurate simulator with corresponding instructions of the program.

3. The method of claim 1 further comprising:
presenting the performance information from the cycle accurate simulator with corresponding instructions of the program on a display.

4. The method of claim 1 wherein:
the analyzing includes generating performance statistics based upon the information.

5. The method of claim 4 wherein:
the performance statistics include a total number of cycles for executing the program, an average number of cycles to execute an instruction in the program.

6. The method of claim 4 wherein:
the performance statistics include at least one of cache miss information, stall cycle information and retirement cycle information for an instruction in the program.

7. The method of claim 6 wherein:
the cache miss information includes at least one of level 1 cache miss information, level 2 cache miss information, and external memory miss information.

8. The method of claim 6 wherein:
the stall information includes at least one of a number of cycles that the instruction is waiting for data in a cache, a number of cycles that the instruction is waiting for a functional unit to become available, and a number of cycles that the instruction is waiting for an internal processor buffer to become available.

9. An apparatus for analyzing performance using a cycle accurate simulator comprising:
means for executing a program on a processor model;
means for collecting data and instruction trace information from the processor model;
means for obtaining snapshot information and cache warming information from the data and instruction trace information;
means for executing the snapshot information on the cycle accurate simulator;
means for collecting performance information from the cycle accurate simulator;
means for mapping the performance statistics to instruction level, function level and source level; and
means for analyzing the performance information to identify possible performance enhancements to the processor.

10. The apparatus of claim 9 further comprising:
means for aggregating the performance information from the cycle accurate simulator with corresponding instructions of the program.

11. The apparatus of claim 9 further comprising:
means for presenting the performance information from the cycle accurate simulator with corresponding instructions of the program on a display.

12. The apparatus of claim 9 wherein:
the means for analyzing includes means for generating performance statistics based upon the information.

13. The apparatus of claim 12 wherein:
the performance statistics include a total number of cycles for executing the program, an average number of cycles to execute an instruction in the program.

14. The apparatus of claim 12 wherein:
the performance statistics include at least one of cache miss information, stall cycle information and retirement cycle information for an instruction in the program.

15. The apparatus of claim 14 wherein:
the cache miss information includes at least one of level 1 cache miss information, level 2 cache miss information, and external memory miss information.

16. The apparatus of claim 14 wherein:
the stall information includes at least one of a number of cycles that the instruction is waiting for data in a cache, a number of cycles that the instruction is waiting for a functional unit to become available, and a number of cycles that the instruction is waiting for an internal processor buffer to become available.

17. A simulator comprising:
a processor model, the processor model receiving and providing information to a trace file to execute a program, collecting trace information from the processor model via the trace file;
a cycle accurate simulator, the cycle accurate simulator obtaining snapshot information and cache warming information from the trace information and executing the snapshot information on the cycle accurate simulator;
a performance statistic analyzer, the performance statistic analyzer collecting performance information from the cycle accurate simulator, mapping the performance statistics to instruction, function and source code level, and analyzing the performance information.

18. The simulator of claim 17 wherein
the performance statistic analyzer aggregates the performance information from the cycle accurate simulator with corresponding instructions of the program.

19. The simulator of claim 17 wherein:
the performance statistic analyzer presents the performance information from the cycle accurate simulator with corresponding instructions of the program on a display.

20. The simulator of claim 17 wherein:
the performance analyzer generates performance statistics based upon the information.

21. The simulator of claim 20 wherein:
the performance statistics include a total number of cycles for executing the program, an average number of cycles to execute an instruction in the program.

22. The simulator of claim 20 wherein:
the performance statistics include at least one of cache miss information, stall cycle information and retirement cycle information for an instruction in the program.

23. The simulator of claim 22 wherein:
the cache miss information includes at least one of level 1 cache miss information, level 2 cache miss information, and external memory miss information.

24. The simulator of claim 22 wherein:
the stall information includes at least one of a number of cycles that the instruction is waiting for data in a cache, a number of cycles that the instruction is waiting for a functional unit to become available, and a number of cycles that the instruction is waiting for an internal processor buffer to become available.
